(19) United States
(12) Patent Application Publication
(10) Pub. No.: US 2019/0279156 A1
(43) Pub. Date: Sep. 12, 2019

(54) SYSTEM AND METHOD FOR THE ENERGY-SAVING TRANSPORTATION OF OBJECTS

(71) Applicant: SENDbyFRIEND GmbH, Eppenrod (DE)

(72) Inventor: Konstanze SCHLOSSER-SCHRAMM, Eppenrod (DE)

(21) Appl. No.: 16/461,219

(22) PCT Filed: Sep. 27, 2017
(86) PCT No.: PCT/EP2017/074464

§ 371 Date: May 15, 2019

(30) Foreign Application Priority Data
Nov. 16, 2016 (LU) 93310

(51) Int. Cl. G06Q 10/08

(52) U.S. Cl. CPC G06Q 10/08355; G06Q 10/0838

(57) ABSTRACT

The invention relates to a system and to a method for the energy-saving transportation of objects. The system has a multiplicity of communication modules, wherein each communication module is unambiguously assigned to at least one person of a multiplicity of people, and wherein each communication module is designed and configured for the inputting of at least one item of meeting information about a future meeting between at least two of the multiplicity of people. The system furthermore has a storage module, spatially separate from the communication modules, in which the meeting information input by way of the communication modules is stored. The system furthermore has at least one transportation request module, into which a transportation request that contains at least information about a sender and a transport recipient is able to be input by a sender, and which sends the input transportation request. The system lastly has a calculation module, separate from the transportation request module, which receives the transportation request from the communication module and which determines a sequence of different people from the stored meeting information, taking into account the item of information about the sender and the transport recipient, wherein an item of meeting information is present for immediately consecutive people in the sequence and wherein the sender is the first person in the sequence and wherein the transport recipient is the last person in the sequence.

### CROSS-REFERENCE TO RELATED APPLICATIONS

The present application is the U.S. national phase of International Application No. PCT/EP2017/074464 filed Sep. 27, 2017, which claims priority of Luxembourgian Application No. 93310 filed Nov. 16, 2016, the entire disclosure of which is incorporated herein by reference.

### FIELD OF THE INVENTION

The invention relates to a system and to a method for the energy-saving transportation of objects.

### BACKGROUND OF THE INVENTION

An object is generally sent to a particular destination by transferring the object to a shipping company. The shipping company then brings the object to the destination either directly or via intermediate stations, wherein the transport means required for the transportation, such as vehicles and sorting devices, are operated solely for this purpose. To this extent, the energy required to operate the transport means is used solely to transport objects. Seen from another point of view, the situation is as follows: Many vehicles travel every day, some of which vehicles are operated, with a considerable expenditure of energy, for the sole purpose of transporting objects.

It is also known to at least partly dispense with commercial parcel services by having private individuals act as occasional couriers who still deliver a parcel quickly on their way to work, for example. In this case, the shipments are deposited beforehand at stationary transshipment points and picked up from there by private individuals for delivery. Such a procedure is known as crowdshipping.

DE 10 2011 084 282 A1 discloses for example a method for delivering a postal consignment to a destination address, wherein the postal consignment is provided at one base from a plurality of bases. In the method, a first participant of a service is selected from a plurality of participants registered for the service on the basis of an assignment of the participant to the base, a request is sent to the selected first participant and an acceptance message, sent in response to the request, of the participant is received and the postal consignment is transferred to the first participant on the basis of the reception of the acceptance message for transportation on at least part of a delivery route to the destination address at the base.

Crowdshipping has the disadvantage that, in the same way as in the case of a delivery by a delivery service, and in a manner that increases energy expenditure, additional routes have to be covered, for example in order to pick up the parcel to be delivered from a transshipment station for further transportation. It is furthermore technically complex to compile the required route and time information, for example regarding travel, work or shopping routes of various people, and to evaluate it to determine possible transfer points and times.

### SUMMARY OF THE INVENTION

The object of the present invention is therefore to specify a system that enables energy-saving transportation of objects.

The object is achieved by a system that is characterized by:
a. a multiplicity of communication modules, wherein each communication module is unambiguously assigned to at least one person of a multiplicity of people, and wherein each communication module is designed and configured for the inputting of at least one item of meeting information about a future meeting between at least two of the multiplicity of people,
b. a storage module, spatially separate from the communication modules, in which the meeting information input by way of the communication modules is stored,
c. at least one transportation request module, into which a transportation request that contains at least information about a sender and a transport recipient is able to be input by a sender, and which sends the input transportation request, and
   a calculation module, separate from the transportation request module, which receives the transportation request from the communication module and which determines a sequence of different people from the stored meeting information, taking into account the item of information about the sender and the transport recipient, wherein an item of meeting information is present for immediately consecutive people in the sequence and wherein the sender is the first person in the sequence and wherein the transport recipient is the last person in the sequence.

A further object of the present invention is to specify a method that enables energy-saving transportation of objects.

This object is achieved by a method that is characterized by the following steps:
a. inputting meeting information about the future meetings between in each case at least two of a multiplicity of people in a storage module, wherein inputting is performed by each of the people via a communication module assigned to them,
b. transmitting the meeting information to a storage module, spatially separate from the communication modules, in which the meeting information input by way of the communication modules is stored,
c. inputting a transportation request, which contains at least information about a sender and a transport recipient, into a transportation request module, which sends the input transportation request, and
d. determining a sequence of different people from the stored meeting information, taking into account the item of information about the sender and the transport recipient, by way of a calculation module separate from the transportation request module, wherein an item of meeting information is present for immediately consecutive people in the sequence and wherein the sender is the first person in the sequence and wherein the transport recipient is the last person in the sequence.

A key inventive concept of the present invention lies in that of reducing the energy requirement for the transportation of objects in that no meetings that need to be arranged and performed for the sole purpose of transportation, in particular for transferring the object to be transported, are necessary. Such meetings require in particular additional routes to be covered in order to find a transfer location or a transshipment point agreed beforehand for the sole purpose of the transportation. A serious disadvantage of crowdshipping, namely that energy is consumed to a considerable extent solely for transportation purposes, because the couriers have to cover diversions and extra routes, is avoided by virtue of the present invention.

A further key inventive concept of the present invention lies in that of reducing the energy requirement of the technical overall system of all vehicles in that objects are transported so as to be sent along with the transport means of those people who will be meeting up anyway. The invention therefore has the quite particular advantage that the resource consumption, in particular the energy requirement, for the transportation of objects is very considerably reduced. To this extent, the energy requirement of the technical overall system of all vehicles, for example in a country or in a region, is very considerably reduced.

The invention has the further advantage that the couriers, at least the immediately consecutive people in the determined sequence, know one another personally, which makes the transportation particularly safe and reliable and agreeable.

It is furthermore advantageously not necessary to arrange and perform a contrived meeting for the sole purpose of transferring an object. It is in particular not necessary to arrange and perform a contrived meeting with unknown people for the sole purpose of transferring an object.

The system is all the more effective and the saving is all the greater the more people input meeting information, in particular via a communication module assigned to them, and transmit it for storage and evaluation. In this case, with regard to the complexity of the information to be stored, it is particularly advantageous for it to be enough for an item of meeting information only to contain indications of who the people involved in the future meeting are. Advantageously, it is not necessary—but still by all means possible—for the item of meeting information to contain indications about the time and/or location of the future meeting.

The object is transported by the sender transferring the object to the second person in the determined sequence at a meeting that is upcoming in any case. Said second person transfers the object at a meeting that is upcoming in any case to the third person in the determined sequence, and so on, until the object has reached the transport recipient. The sequence may in particular contain more than two people, in particular more than three people. There may in particular also advantageously be provision for more than one transfer, in particular more than two transfers, to take place before the object reaches the transport recipient. This advantageously also makes it possible to send to people a great distance away.

It is not necessary to indicate the location, because the location at which the object is in each case transferred is irrelevant to the described transportation of the object.

It is likewise in principle not necessary to indicate the times of the meetings in order to be able to perform the transportation. It is however advantageous if the item of meeting information contains indications about the time of the meeting between the at least two people, because, based on the times, the transportation duration is able to be determined in advance, in particular for a plurality of alternative sequences of people.

To this end, there may also in particular be provision for example for the item of meeting information to contain indications about the regularity of future meetings between the at least two people. A detail in relation to the regularity may for example consist of the item of information as to how often a meeting takes place, for example daily, weekly, monthly or for example on every 13th and 21st of a month.

A transportation request is input via a transportation request module. A transportation request may particularly advantageously be input via a transportation request module that is one of the communication modules of the multiplicity of communication modules. There may advantageously in particular be provision for each of the communication modules also to be designed for the inputting of transportation requests.

By way of example, the communication module and/or the transportation request module may be designed as a PC or a smartphone or a tablet PC or contain such a device. There may advantageously in particular be provision for parts of the item of meeting information, such as a telephone number or an address, to be added as additional information—in particular automatically—to the personal contacts stored on the communication module.

In one advantageous configuration, at least one transportation parameter, which is taken into account by the calculation module in the determination of the sequence, is additionally able to be input via the transportation request module.

There may advantageously in particular be provision for the calculation module to determine a plurality of alternative sequences that are characterized by different transportation parameters. The sender is then able to decide on one of the possible sequences displayed to him.

By way of example, a transportation parameter may relate to the determination of the sequence for the quickest transportation. It is also possible for example for a transportation parameter to relate to the determination of the sequence for the safest transportation or the determination of the sequence involving people to whom the best ratings have been given by other people, or to relate to the determination of the sequence involving the lowest number of people.

In one advantageous configuration, the calculation module for the determined sequence determines a transportation duration for the transportation from the transport starting point to the transport destination and communicates this to the sender, preferably by transmitting it to the transportation request module.

In one very particularly advantageous configuration, the calculation module takes into account the current whereabouts of the people in the determination. This may take place for example by evaluating those mobile radio cells of a mobile radio network in which the communication modules of the people and/or separate mobile telephones of the people are in each case currently registered. In this way, it is for example able to be compared whether the meeting information stored in the storage module is plausible and/or expediently able to be used for transportation currently needing to be performed. By way of example, it may thus be discovered that a future meeting for transportation from a sender in Germany to a transport recipient in Germany cannot take place soon if one of the people in the determined sequence is currently located in Australia.

It is also possible for the sequence for transportation to be changed if it is established, for example on the basis of the determination of the current whereabouts of the people intended for transportation, that transportation is not possible without disruption, for example due to one person being ill.

After the calculation module has determined a sequence of people, it preferably communicates this to the sender, and does so preferably by transmitting a corresponding item of information to the transportation request module. Furthermore, the calculation module preferably communicates the identities of the people in the sequence to the sender. This allows the sender to ask each of the people whether they have already received the object or whether they have already forwarded the object.

There may furthermore advantageously be provision for the calculation module to transmit at least one item of transportation information to the people in the sequence and/or to the communication modules of the people in the sequence. The item of transport information may in particular contain an item of information about the fact that transportation involving a particular sequence of people was bindingly booked by the sender.

There may furthermore advantageously be provision for the calculation module to transmit at least one item of transfer information and/or one item of object information in each case to the immediately consecutive people in the sequence and/or to their communication modules.

In one particular configuration, the calculation module assigns the people in the sequence at least one item of object information about the object to be transported. This may in particular be a unique identification code and/or information about the type and size of the object to be transported.

In one particularly advantageous configuration, the calculation module determines the serquence at least partly using a Dijkstra algorithm.

In a further particular configuration, the item of meeting information additionally contains an item of information about a maximum transfer and transport capacity, for example in the form of indications about the maximum possible dimensions and/or the maximum possible weight of the object to be transported. This has the particular advantage that the calculation module takes into account only suitable people when determining the sequence for particular transportation, for example for the transportation of a particularly large and heavy object.

### BRIEF DESCRIPTION OF THE DRAWING VIEWS

The subject matter of the invention is illustrated by way of example and schematically in the drawing, and is described below with reference to the figures, wherein identical or functionally identical elements are for the most part provided with the same reference signs, including in different exemplary embodiments. Here, in the figures:

FIG. 1 schematically shows, by way of example, one exemplary embodiment of a system according to the invention for the energy-saving transportation of objects, and

FIG. 2 shows a schematic illustration of the operation of the system according to the invention for saving energy and transporting objects.

### DETAILED DESCRIPTION OF THE INVENTION

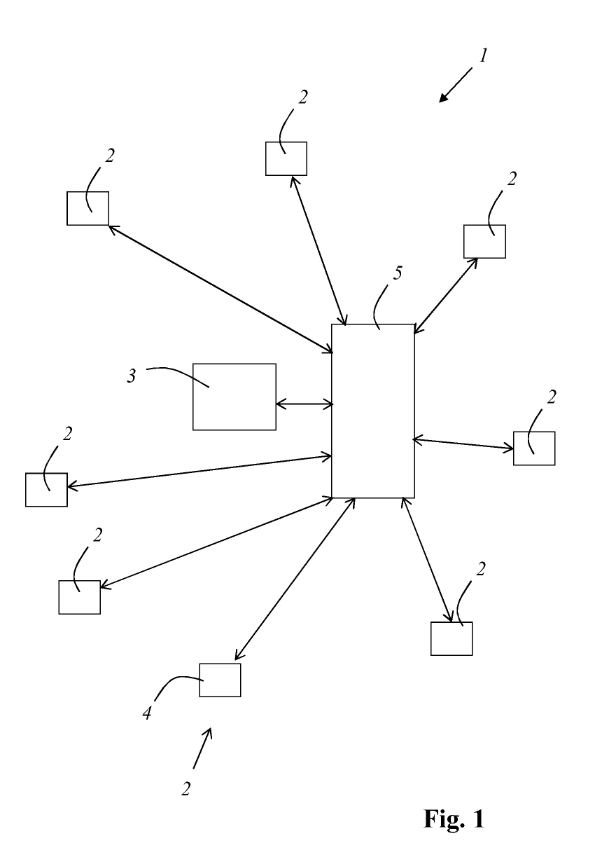

FIG. 1 schematically shows, by way of example, a system 1 for the energy-saving transportation of objects. The system contains a multiplicity of communication modules 2, wherein each communication module 2 is unambiguously assigned to at least one person of a multiplicity of people, and wherein each communication module 2 is designed and configured for the inputting of at least one item of meeting information about a future meeting between at least two of the multiplicity of people.

The system 1 furthermore has a storage module 3, spatially separate from the communication modules 2, in which the meeting information, input by way of the communication modules 2, about a future meeting between at least two of the multiplicity of people is stored.

The system furthermore contains a transportation request module 4, which may likewise be designed as a communication module 2. The transportation request module 4 is designed and intended for the inputting of a transportation request that contains at least one item of information about a sender and a transport recipient. The transportation request module 4 sends the transportation request to a calculation module 5. The calculation module 5 determines a sequence of people from the meeting information stored in the storage module, taking into account the communicated sender and the communicated transport recipient, wherein an item of meeting information is present for immediately consecutive people in the sequence and wherein the sender is the first person in the sequence and wherein the transport recipient is the last person in the sequence.

It is thereby made possible for the sender to transfer the object to be transported to the second person in the determined sequence at the meeting that is upcoming in any case and for which an item of meeting information was input and transmitted. Said second person transfers the object at a meeting that is upcoming in any case and for which an item of meeting information was likewise input and transmitted to the third person in the determined sequence, and so on, until the object has reached the transport recipient.

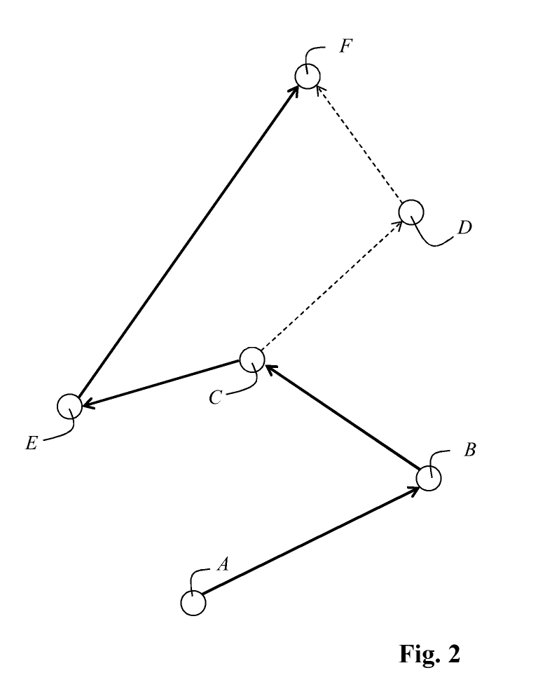

FIG. 2 schematically illustrates, by way of example, the operation of the system for the energy-saving transportation of objects.

A person A has input, via their communication module 2, that they regularly meet a person B, for example every day at work.

Person B has input, via their communication module 2, that they always meet person C on Tuesdays and Fridays.

A person D and a person E have each input, via their communication module 2, that they will meet person C and that they meet person F, wherein person D meets person F once a month and person E every day.

If person A, as sender, has then input a transportation request via his transportation request module, which transportation request contains an indication that an object should be transported from person A to person F as transport recipient, an additional transportation parameter having been input that the process should be performed as quickly as possible, then the calculation module 5 determines a sequence of people, which is illustrated by the arrow in bold in FIG. 2. This sequence contains people A, B, C, E and F.

Since people E and F meet daily, this transportation is quicker than the other possible transportation (indicated in dashed form) via person D, with whom person F meets just once a month.

The calculation module 5 communicates this sequence to person A, the sender. The sender will then transfer the object to person B at the next upcoming meeting. Person B transfers the object to person C at the next upcoming meeting, person C transfers it to person E, and person E lastly transfers it to person F.

### LIST OF REFERENCE SIGNS

1 System
2 Communication modules
3 Storage module
4 Transportation request module
5 Calculation module
A to F People

1. A system (1) for energy-saving transportation of an object to be transported, comprising:
a. a multiplicity of communication modules (2), wherein each communication module (2) is unambiguously assigned to at least one person of a multiplicity of people, and wherein each communication module (2) is designed and configured for the inputting of at least one item of meeting information about a future meeting between at least two of the multiplicity of people,
b. a storage module (3), spatially separate from the communication modules (2), in which the meeting information input by way of the communication modules (2) is stored,
c. at least one transportation request module (4), into which a transportation request that contains at least information about a sender and a transport recipient is able to be input by a sender, and which sends the input transportation request, and
d. a calculation module (5), separate from the transportation request module (4), which receives the transportation request from the communication module (2) and which determines a sequence of different people from the stored meeting information, taking into account the item of information about the sender and the transport recipient, wherein an item of meeting information is present for immediately consecutive people in the sequence and wherein the sender is the first person in the sequence and wherein the transport recipient is the last person in the sequence.

2. The system (1) according to claim 1, wherein the item of meeting information contains an item of information about a time of the meeting between the at least two people.

3. The system (1) according to claim 1, wherein the item of meeting information contains an item of information about a regularity of future meetings between the at least two people.

4. The system (1) according to claim 1, wherein the item of meeting information does not contain any information about a location of the meeting and/or the system is able to be operated without information about the location of the meeting.

5. The system (1) according to claim 1, wherein
a. the transportation request module (4) is one of the communication modules (2) of the multiplicity of communication modules (2), and/or
b. each of the communication modules (2) is also designed for the inputting of transportation requests.

6. The system (1) according to claim 1, wherein at least one transportation parameter is able to be input via the transportation request module (4) and the calculation module determines the sequence taking into account the at least one transportation parameter.

7. The system (1) according to claim 1, wherein the calculation module (5) determines a plurality of alternative sequences and/or the calculation module (5) determines a plurality of alternative sequences that are characterized by different transportation parameters.

8. The system (1) according to claim 6, wherein
a. a transportation parameter relates to the determination of the sequence for the quickest transportation and/or
b. a transportation parameter relates to the determination of the sequence for the safest transportation and/or
c. a transportation parameter relates to the determination of the sequence involving people to whom the best ratings have been given by other people, and/or
d. a transportation parameter relates to the determination of the sequence involving the lowest number of people, and/or
e. a transportation parameter relates to the determination of the sequence involving people having a transfer and transport capacity suitable for the object to be transported.

9. The system (1) according to claim 1, wherein the calculation module (5) for the determined sequence determines a transportation duration for the transportation from the sender to the transport recipient and communicates the transportation duration to the sender and/or transmits the transportation duration to the transportation request module (4).

10. The system (1) according to claim 1, wherein the calculation module (5) takes into account the current whereabouts of the people of the multiplicity of people in the determination.

11. The system (1) according to claim 1, wherein the calculation module (5) communicates the determined sequence to the sender and/or transmits the determined sequence to the transportation request module (4).

12. The system (1) according to claim 11, wherein the calculation module (5) communicates the identities of the people in the determined sequence to the sender and/or transmits the identities of the people in the determined sequence to the transportation request module (4).

13. The system (1) according to claim 1, wherein the calculation module (5) transmits at least one item of transportation information to the people in the determined sequence and/or to the communication modules (2) of the people in the determined sequence.

14. The system (1) according to claim 1, wherein the calculation module (5) transmits at least one item of transfer information in each case to the respectively immediately consecutive people in the sequence and/or to the communication modules (2) of the respectively immediately consecutive people in the sequence.

15. The system (1) according to claim 1, wherein the calculation module (5) assigns the determined sequence at least one item of object information about the object to be transported, which item of object information contains an identification code.

16. The system (1) according to claim 1, wherein the calculation module (5) determines a new sequence if the transportation of the object is disrupted.

17. The system (1) according to claim 1, wherein the communication module (2) and/or the transportation request module (4) is a PC or a smartphone or a tablet PC or the communication module (2) and/or the transportation request module (4) contains a PC or a smartphone or a tablet PC.

18. A method for energy-saving transportation of an object, comprising the following steps:
a. inputting meeting information about future meetings between at least two of a multiplicity of people in a storage module, wherein inputting is performed by each of the multiplicity of people via a communication module (2) assigned to each of the multiplicity of people,
b. transmitting the meeting information to a storage module (3), spatially separate from the communication modules (2), in which the meeting information input by way of the communication modules (2) is stored,
c. inputting a transportation request, which contains at least information about a sender and a transport recipient, into a transportation request module (4), which sends the input transportation request, and
d. determining a sequence of different people from the stored meeting information, taking into account the item of information about the sender and the transport recipient, by way of a calculation module (5) separate from the transportation request module (4), wherein an item of meeting information is present for immediately consecutive people in the sequence and wherein the sender is the first person in the sequence and wherein the transport recipient is the last person in the sequence.

19. The method according to claim 18, wherein the item of meeting information contains an item of information about a time of the meeting between the at least two people.

20. The method according to claim 18, wherein the item of meeting information contains an item of information about a regularity of future meetings between the at least two people.

21. The method according to claim 18, wherein the item of meeting information does not contain any information about a location of the meeting and/or the method is able to be performed without information about the location of the meeting.

22. The method according to claim 18, wherein the transportation request module (4), by way of which the transportation request is input, is one of the communication modules (2) of the multiplicity of communication modules (2).

23. The method according to claim 18, wherein at least one transportation parameter is input via the transportation request module (4) and an order of the sequence is determined taking into account the transportation parameter.

24. The method according to claim 18, wherein a plurality of alternative sequences are determined and/or a plurality of alternative sequences that are characterized by different transportation parameters are determined.

25. The method according to claim 23, wherein
a. a transportation parameter relates to the determination of the sequence for the quickest transportation and/or
b. a transportation parameter relates to the determination of the sequence for the safest transportation and/or
c. a transportation parameter relates to the determination of the sequence involving people to whom the best ratings have been given by other people, and/or
d. a transportation parameter relates to the determination of the sequence involving the lowest number of people, and/or
e. a transportation parameter relates to the determination of the sequence involving people having a transfer and transport capacity suitable for the object to be transported.

26. The method according to claim 18, wherein, for the determined sequence, a transportation duration for transportation of the object from the sender to the transport recipient is determined and the transportation duration is communicated to the sender and/or is transmitted to the transportation request module (4).

27. The method according to claim 18, wherein the determined sequence is communicated to the sender and/or is transmitted to the transportation request module (4).

28. The method according to claim 27, wherein the identities of the people in the determined sequence are communicated to the sender and/or are transmitted to the communication module (2).

29. The method according to claim 18, wherein at least one item of transportation information is transmitted to the people in the determined sequence and/or to the communication modules (2) of the people in the determined sequence.

30. The method according to claim 18, wherein at least one item of transfer information is in each case transmitted to the respectively immediately consecutive people in the sequence and/or to the communication modules (2) of the respectively immediately consecutive people in the sequence.

31. The method according to claim 18, wherein the determined sequence is assigned at least one item of object information about the object to be transported, which item of object information in particular contains an identification code, and is sent to the people in the determined sequence.

32. The method according to claim 18, wherein a new order is automatically determined if transportation of the object is disrupted.
